(19) United States
(12) Patent Application Publication
(10) Pub. No.: US 2021/0101544 A1
(43) Pub. Date: Apr. 8, 2021

(54) GROMMET AND WIRE HARNESS

(71) Applicant: Yazaki Corporation, Tokyo (JP)

(72) Inventors: Yasunori HATTORI, Aichi (JP); Katsuya YOSHIMURA, Aichi (JP); Ryohei TOYODA, Aichi (JP)

(73) Assignee: Yazaki Corporation, Tokyo (JP)

(21) Appl. No.: 17/063,925

(22) Filed: Oct. 6, 2020

(30) Foreign Application Priority Data
Oct. 7, 2019 (JP) 2019-184309

(51) Int. Cl. B60R 16/02

(52) U.S. Cl. CPC B60R 16/0222

(57) ABSTRACT

A grommet includes a main body having a ring-shaped water-stop portion inserted into a through-hole formed in an attachment panel for stopping water and a cylindrical portion that is provided to penetrate through an annular inner side of the water-stop portion and through which wiring materials are inserted and a pressing portion inserted into the annular inner side of the water-stop portion in the main body and pressing the water-stop portion against the inner edge of the through-hole. A wire harness includes the above-mentioned grommet and the wiring materials having conductivity.

### CROSS-REFERENCE TO RELATED APPLICATION(S)

The present application claims priority to and incorporates by reference the entire contents of Japanese Patent Application No. 2019-184309 filed in Japan on Oct. 7, 2019.

### BACKGROUND OF THE INVENTION

### 1. Field of the Invention

The present invention relates to a grommet and a wire harness.

### 2. Description of the Related Art

As a conventional grommet that is mounted on a vehicle, for example, Japanese Patent Application Laid-open No. 2017-010638 discloses a grommet that is attached to a through-hole formed in a vehicle body panel into which a wire harness is inserted. The grommet includes a small-diameter cylindrical portion, a large-diameter cylindrical portion, a closure face portion, and an auxiliary cylindrical portion. The small-diameter cylindrical portion has a through-hole through which the wire harness is inserted. The large-diameter cylindrical portion is formed so as to project outward from the small-diameter cylindrical portion and extend in the axial direction of the small-diameter cylindrical portion and, has, in an outer circumferential portion thereof, a ring-shaped groove into which a peripheral edge portion of a through-hole can be fitted. The closure face portion extends inward in the radial direction from an inner circumferential surface of the large-diameter cylindrical portion and closes the large-diameter cylindrical portion. The auxiliary cylindrical portion extends to one side in an axial direction from the closure face portion and forms a through-hole through which the wire harness is inserted.

The grommet as described in Japanese Patent Application Laid-open No. 2017-010638 has, in the outer portion of the large-diameter cylindrical portion, the ring-shaped groove into which the peripheral edge portion of the through-hole can be fitted to ensure water-stopping performance in mounting a grommet but needs large insertion force for being fitted into the through-hole in mounting a grommet.

### SUMMARY OF THE INVENTION

The present invention has been made in view of the above-mentioned circumstances and an object thereof is to provide a grommet and a wire harness that are capable of ensuring water-stopping performance and improving mountability.

In order to achieve the above mentioned object, a grommet according to one aspect of the present invention includes a main body having a ring-shaped water-stop portion that is inserted into a through-hole formed in an attachment panel for stopping water and a cylindrical portion that is provided to penetrate through an annular inner side of the water-stop portion and through which a wiring material is inserted; and a pressing portion inserted into the annular inner side of the water-stop portion in the main body and pressing the water-stop portion against an inner edge of the through-hole.

According to another aspect of the present invention, in the grommet, it is possible to configure that the water-stop portion and the pressing portion have contact surfaces making surface contact with each other.

According to still another aspect of the present invention, in the grommet, it is possible to configure that an inner diameter i of the water-stop portion and an outer diameter h of the pressing portion satisfy a relation of i<h.

According to still another aspect of the present invention, in the grommet, it is possible to configure that the water-stop portion has, in an outer circumference, a recess that is locked in the through-hole, and a recessed part of the recess is formed to have a smallest thickness in the other parts of the water-stop portion.

According to still another aspect of the present invention, in the grommet, it is possible to configure that the pressing portion is formed into a continuous ring shape.

According to still another aspect of the present invention, in the grommet, it is possible to configure that the pressing portion is made of a material harder than the water-stop portion.

In order to achieve the above mentioned object, a wire harness according to still another aspect of the present invention includes a wiring material having conductivity; and a grommet provided for the wiring material, wherein the grommet includes: a main body having a ring-shaped water-stop portion that is inserted into a through-hole formed in an attachment panel for stopping water and a cylindrical portion that is provided to penetrate through an annular inner side of the water-stop portion and through which the wiring material is inserted; and a pressing portion inserted into the annular inner side of the water-stop portion in the main body and pressing the water-stop portion against an inner edge of the through-hole.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a cross-sectional view illustrating a grommet and a wire harness according to an embodiment;

FIG. 2 is an exploded perspective view of the grommet according to the embodiment;

FIG. 3 is an exploded perspective view illustrating the grommet according to the embodiment when seen from another direction; and

FIG. 4 is an exploded cross-sectional view illustrating the grommet according to the embodiment.

### DETAILED DESCRIPTION OF THE PREFERRED EMBODIMENTS

Hereinafter, an embodiment according to the present invention will be described in detail with reference to the drawings. The embodiment does not limit the present invention. Components in the following embodiment include those that can be easily replaced by those skilled in the art and that are substantially the same.

### Embodiment

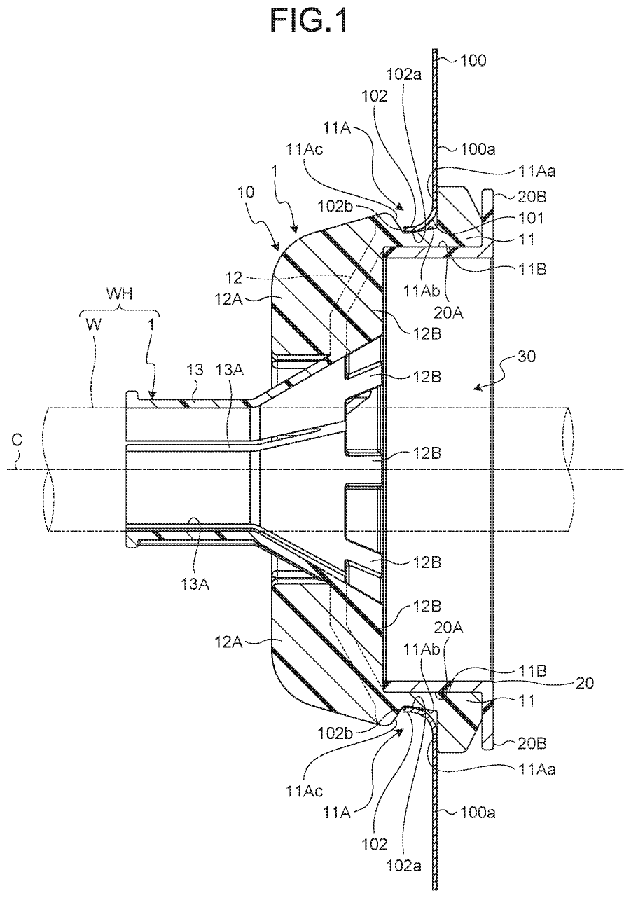

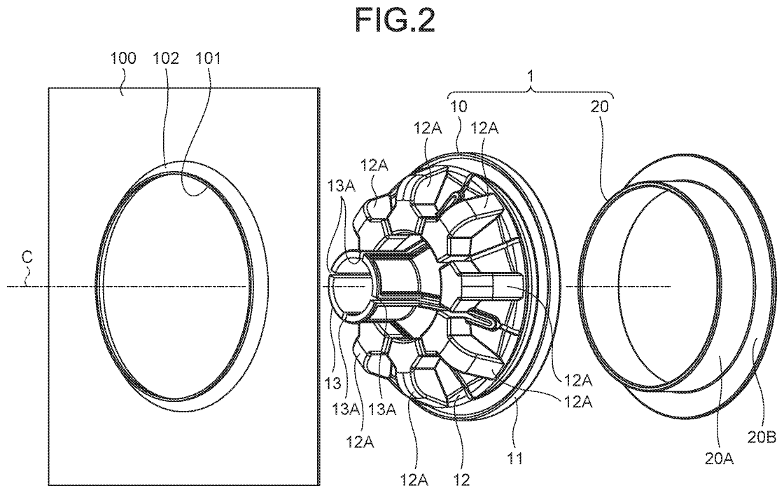

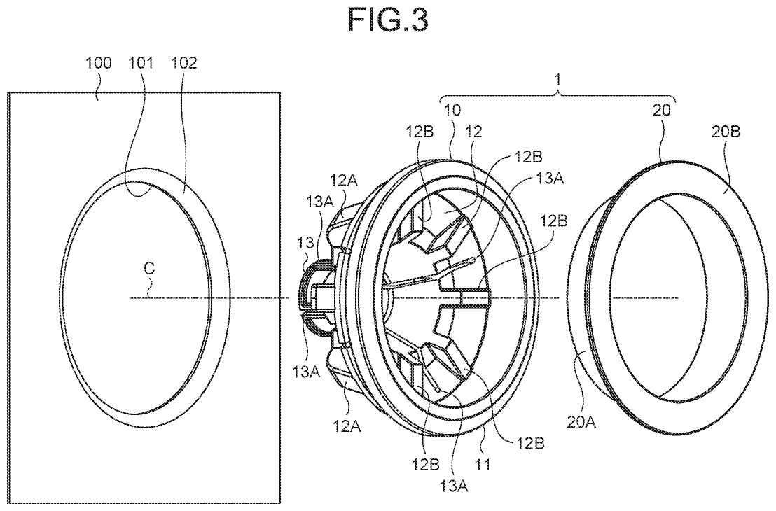

A grommet 1 in the embodiment illustrated in FIG. 1 to FIG. 4 is incorporated into a wire harness WH as illustrated in FIG. 1. The wire harness WH is routed in a vehicle or the like. The wire harness WH forms an assembly component by bundling a plurality of wiring materials W that are used for power supply and signal communication in order to connect the devices mounted on the vehicle, and connects the wiring materials W to devices with a connector or the like, for examples. The wire harness WH includes the wiring materials W having conductivity and the grommet 1 that is provided for the wiring materials W and into which the wiring materials W are inserted. The wire harness WH may further include various components exemplified by an exterior member such as a corrugate tube, a resin tape, and a protector, an electric connection box, and a fixture tool. The wiring material W is configured by, for example, a metal bar, an electric wire, or an electric wire bundle. The metal bar is configured by covering an outer portion of a bar-like member having conductivity with a covering portion having an insulation property. The electric wire is configured by covering an outer portion of a conductor portion (core wire) formed by a plurality of metal strands having conductivity with a covering portion having an insulation property. The electric wire bundle is configured by bundling the electric wires. The wire harness WH bundles and integrates the wiring materials W and is electrically connected to various devices via the connector or the like provided at the terminals of the bundled wiring materials W.

The grommet 1 is applied to a through-hole 101 formed in an attachment panel 100 as an attachment target when the wiring materials W are routed through the through-hole 101 across two spaces divided by the attachment panel 100 serving as a boundary. The attachment panel 100 is, for example, a metal plate configuring a body of the vehicle, and the through-hole 101 penetrates through the attachment panel 100 in a ring form along the thickness direction. The two spaces that are divided by the attachment panel 100 serving as the boundary are typically a vehicle inside space (for example, a cabin) and a vehicle outside space (for example, an engine compartment). The thickness direction of the attachment panel 100 along which the through-hole 101 penetrates through is referred to as an axial direction. A center line C passing through the center of the through-hole 101 is orthogonal to the panel surface of the attachment panel 100 and extends along the axial direction. Accordingly, the axial direction corresponds to the direction in which the center line C illustrated in FIG. 1 to FIG. 4 extends. The direction orthogonal to the center line C is referred to as a radial direction, and the side away from the center line C is referred to as the outer side in the radial direction whereas the side closer to the center line C is referred to as the inner side in the radial direction. Burring processing of forming a rising portion 102 in which the inner edge of the through-hole 101 projects to one side in the axial direction is performed on the attachment panel 100. The inside of the rising portion 102 is formed as the through-hole 101.

The grommet 1 is fitted into the through-hole 101 in a state where the wiring materials W of the wire harness WH are inserted into the grommet 1 and the grommet 1 is externally fitted around the wiring materials W. The grommet 1 therefore protects the wiring materials W passing through the through-hole 101 and stops (prevents) water flowing through the through-hole 101. The grommet 1 has dustproof and sound insulation functions and the like in addition to the waterproof function of the through-hole 101. Hereinafter, the configuration of the grommet 1 will be described in detail with reference to the drawings.

The grommet 1 in the embodiment includes a main body 10 and a pressing portion 20 as illustrated in FIG. 1 to FIG. 4.

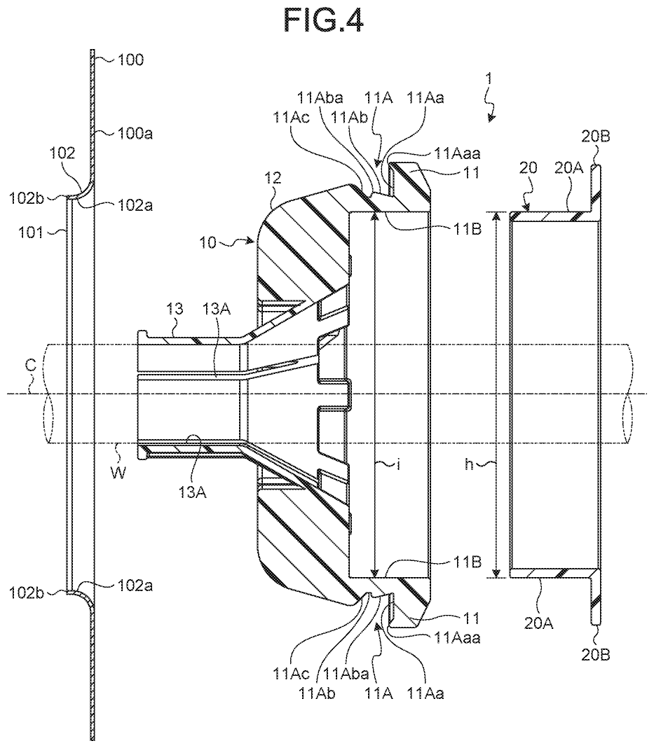

The main body 10 includes a water-stop portion 11, a closure portion 12, and a cylindrical portion 13. The water-stop portion 11 is a seal member that is inserted into the through-hole 101 of the attachment panel 100 and stops water between the grommet 1 and the through-hole 101. The water-stop portion 11 is formed into a ring shape so as to correspond to a ring shape of the through-hole 101. In the embodiment, the through-hole 101 is formed into a circular shape, and the water-stop portion 11 is also formed into a circular shape. When the through-hole 101 is formed into an elliptical shape, the water-stop portion 11 is also formed into an elliptical shape. The water-stop portion 11 has, in the outer circumferential surface thereof, a groove-like recess 11A that is continuous in a ring form. As illustrated in FIG. 1, the recess 11A has a first abutment surface 11Aa abutting against a panel surface 100a of the attachment panel 100 on the opposite side to the projecting direction of the rising portion 102 in the attachment panel 100. The recess 11A has a second abutment surface 11Ab abutting against an inner circumferential surface 102a of the rising portion 102. The recess 11A further has a third abutment surface 11Ac abutting against a front end 102b of the rising portion 102. The recess 11A is formed with the second abutment surface 11Ab being a groove bottom as a recessed part and the first abutment surface 11Aa and the third abutment surface 11Ac being groove walls. As illustrated in FIG. 4, the recess 11A has a projecting portion 11Aaa on the outer edge of the first abutment surface 11Aa. The projecting portion 11Aaa is formed into a ring shape about the center line C. The projecting portion 11Aaa abuts against the panel surface 100a of the attachment panel 100 and is elastically deformed to be crushed, thereby functioning as what is called a water-stop lip portion. As illustrated in FIG. 4, the recess 11A has a projecting portion 11Aba on a halfway of the second abutment surface 11Ab. The projecting portion 11Aba is formed into a ring shape about the center line C. The projecting portion 11Aba abuts against the inner circumferential surface 102a of the rising portion 102 and is elastically deformed to be crushed, thereby functioning as what is called a water-stop lip portion. The water-stop portion 11 has a ring-shaped inner circumferential surface (contact surface) 11B on the opposite side to the recess 11A. The inner circumferential surface 11B is formed along the axial direction. In the recess 11A, the second abutment surface 11Ab as the recessed part has the smallest thickness to the inner circumferential surface 11B in the other parts of the water-stop portion 11.

The closure portion 12 configures a partition wall projecting to the inner side of the water-stop portion 11 in the radial direction and closes the annular water-stop portion 11. The closure portion 12 projects from a part of the water-stop portion 11 that corresponds to the third abutment surface 11Ac of the recess 11A to the inner side in the radial direction and the side away from the water-stop portion 11 in the axial direction, and is formed into a substantially conical dome shape. The closure portion 12 thereby closes the part of the axial direction from the part of the water-stop portion 11 that corresponds to the third abutment surface 11Ac of the recess 11A. The closure portion 12 is formed such that the outer diameter thereof is gradually decreased from the water-stop portion 11. As illustrated in FIG. 1 to FIG. 3, the closure portion 12 may have, on both sides in the axial direction, rib-shaped projections 12A and 12B extending in the axial direction that are formed intermittently in the annular direction in order to maintain the shape thereof.

The cylindrical portion 13 is provided by penetrating through the closure portion 12, and the wiring materials W are inserted into the cylindrical portion 13. The cylindrical portion 13 is provided to extend in the axial direction so as to penetrate through the center of the closure portion 12 about the center line C. The cylindrical portion 13 is formed such that the base end thereof extending in the axial direction is connected to the closure portion 12 and the front end thereof being away from the closure portion 12 is open. The cylindrical portion 13 is formed such that a cylinder having a uniform diameter is formed on the front end side and the diameter is increased as the cylindrical portion 13 approaches the closure portion 12 on the base end side. The cylindrical portion 13 may have cutouts 13A. The cutouts 13A extend along the axial direction and are located with intervals in the circumferential direction about the center line C. Four cutouts 13A are provided in the embodiment. Each cutout 13A is provided by extending to the halfway of the closure portion 12 along the axial direction between the projections 12A and 12B of the closure portion 12. The cylindrical portion 13 is divided into a plurality of parts (four parts in the embodiment) in the circumferential direction by the cutouts 13A. Water flowing into the openings of the cylindrical portion 13 is stopped by winding a tape or the like around the divided parts together with the inserted wiring materials W.

The main body 10 having the above-mentioned configuration is made of, for example, an insulating elastic resin material having low rigidity and high flexibility, such as rubber and thermoplastic elastomer (for example, ethylene-propylene-diene rubber (EPDM)). The main body 10 is formed as an elastic body by integration of the water-stop portion 11, the closure portion 12, and the cylindrical portion 13.

The pressing portion 20 is inserted into the annular inner side of the water-stop portion 11 in the main body 10 and presses the water-stop portion 11 against the inner edge of the through-hole 101. The pressing portion 20 is formed into a ring shape that is continuous in the circumferential direction about the center line C. The pressing portion 20 has a ring-shaped outer circumferential surface (contact surface) 20A. The outer circumferential surface 20A is formed along the axial direction. The outer circumferential surface 20A faces and abuts against the inner circumferential surface 11B of the water-stop portion 11. An outer diameter h of the outer circumferential surface 20A of the pressing portion 20 satisfies a relation of i<h for an inner diameter i of the inner circumferential surface 11B of the water-stop portion 11.

The pressing portion 20 has a flange portion 20B that projects to the outer side in the radial direction and is continuous in the circumferential direction about the center line C, in an end part facing the opposite side to the main body 10 on one end side in the axial direction. The flange portion 20B can abut against the end surface of the water-stop portion 11 facing the axial direction in a state where the pressing portion 20 is inserted into the annular inner side of the water-stop portion 11.

The pressing portion 20 having the above-mentioned configuration is made of a material harder than that of the main body 10, for example, a synthetic resin material or a metal material.

As illustrated in FIG. 1, the grommet 1 configured as described above has an internal space portion of the main body 10 (the cylindrical portion 13, the closure portion 12, and the water-stop portion 11) and the pressing portion 20, the internal space portion functioning as an insertion space portion 30. The insertion space portion 30 is a space portion into which the wiring materials W are inserted and is continuous from one side of the main body 10 and the pressing portion 20 to the other side thereof along the axial direction. The wiring materials W are inserted into the insertion space portion 30 of the grommet 1 along the axial direction. The grommet 1 is mounted on the wiring materials W in such a manner that the wiring materials W are inserted into the insertion space portion 30, and then, is inserted into the through-hole 101 from the cylindrical portion 13 side together with the terminals of the wiring materials W.

To be specific, as illustrated in FIG. 4, the grommet 1 is arranged such that the attachment panel 100, the main body 10, and the pressing portion 20 are arranged in this order along the axial direction from one side to the other side in the axial direction. The rising portion 102 of the attachment panel 100 faces one side in the axial direction. The main body 10 is provided such that the cylindrical portion 13 faces the one side in the axial direction, that is, the attachment panel 100 side. The pressing portion 20 is provided such that the outer circumferential surface 20A faces the water-stop portion 11 of the main body 10 and the flange portion 20B is located on the other side in the axial direction. With this arrangement, the wiring materials W are inserted into the water-stop portion 11, the closure portion 12, and the cylindrical portion 13 of the main body 10 and the pressing portion 20.

Thereafter, the terminals of the wiring materials W and the main body 10 of the grommet 1 are inserted into the through-hole 101 of the attachment panel 100 from the cylindrical portion 13 side, and as illustrated in FIG. 1, the rising portion 102 as the inner edge of the through-hole 101 is fitted into the recess 11A of the water-stop portion 11. The main body 10 is inserted into the through-hole 101 in such a manner that the water-stop portion 11 is elastically deformed inward in the radial direction and the recess 11A is fitted as if climbing over the rising portion 102 as the inner edge of the through-hole 101. Thus, excessive force is not required, and assembly can be performed with small force.

After that, in the grommet 1, the pressing portion 20 is inserted into the annular inner side of the water-stop portion 11 and is pressed until the flange portion 20B abuts against the end part of the water-stop portion 11 in the axial direction, as illustrated in FIG. 1. Then, in the grommet 1, the outer circumferential surface 20A of the pressing portion 20 presses the inner circumferential surface 11B of the water-stop portion 11 to the outer side in the radial direction, and the second abutment surface 11Ab of the recess 11A in the water-stop portion 11 is thereby pressed against the rising portion 102 as the inner edge of the through-hole 101. Furthermore, in the grommet 1, the flange portion 20B of the pressing portion 20 presses the water-stop portion 11 to one side in the axial direction, and the first abutment surface 11Aa of the recess 11A in the water-stop portion 11 is thereby pressed against the panel surface 100a of the attachment panel 100 as the periphery of the through-hole 101. As a result, the grommet 1 stops water by pressing of the water-stop portion 11 against the inner edge of the through-hole 101 and the panel surface 100a of the attachment panel 100 as the periphery of the through-hole 101.

In the embodiment, the grommet 1 has the configuration in which the projecting portion 11Aaa is formed on the outer edge of the first abutment surface 11Aa, the projecting portion 11Aba is formed on the halfway of the second abutment surface 11Ab, the projecting portions 11Aaa and 11Aba are elastically deformed to be crushed with pressing force applied by the pressing portion 20, the projecting portion 11Aaa makes close contact with the panel surface 100a of the attachment panel 100, and the projecting portion 11Aba makes close contact with the inner circumferential surface 102a of the rising portion 102. The grommet 1 can therefore seal the entire peripheral edge of the through-hole 101 and provide a water-stop function reliably. Moreover, the grommet 1 stops water flowing into the openings of the cylindrical portion 13 by winding the tape or the like around the inserted wiring materials W and the cylindrical portion 13.

Although not clearly illustrated in the drawings, the pressing portion 20 may be formed to be partially open in the circumferential direction about the center line C. With this configuration, the wiring materials W are not required to be previously inserted into the pressing portion 20.

As described above, in the grommet 1 and the wire harness WH in the embodiment, the grommet 1 includes the main body 10 having the ring-shaped water-stop portion 11 that is inserted into the through-hole 101 formed in the attachment panel 100 for stopping water and the cylindrical portion 13 that is provided by penetrating through the annular inner side of the water-stop portion 11 and through which the wiring materials W are inserted, and the pressing portion 20 inserted into the annular inner side of the water-stop portion 11 in the main body 10 and pressing the water-stop portion 11 against the inner edge of the through-hole 101.

Accordingly, the grommet 1 and the wire harness WH do not need force of pressing the water-stop portion 11 of the main body 10 against the inner edge of the through-hole 101 in insertion of the water-stop portion 11 into the through-hole 101, to eliminate an operation of inserting the main body 10 into the through-hole 101 against the pressing force that causes poor workability. The grommet 1 is thereafter mounted in such a manner that the water-stop portion 11 is pressed against the inner edge of the through-hole 101 by the pressing portion 20. As a result, the grommet 1 and the wire harness WH enable the operation of inserting the water-stop portion 11 of the main body 10 into the through-hole 101 and the operation of pressing the water-stop portion 11 against the inner edge of the through-hole 101 by the pressing portion 20 to be separated, thereby ensuring water-stop performance and improving mountability.

In the grommet 1 and the wire harness WH in the embodiment, the water-stop portion 11 and the pressing portion 20 have the inner circumferential surface 11B and the outer circumferential surface 20A, respectively, as the contact surfaces making surface contact with each other. Accordingly, in the grommet 1 and the wire harness WH, the outer circumferential surface 20A of the pressing portion 20 presses the inner circumferential surface 11B of the water-stop portion 11 to the outer side in the radial direction in surface contact. As a result, the grommet 1 and the wire harness WH enable the pressing force to be transferred on the surface, thereby pressing the water-stop portion 11 against the inner edge of the through-hole 101 reliably.

In the grommet 1 and the wire harness WH in the embodiment, the inner diameter i of the water-stop portion 11 and the outer diameter h of the pressing portion 20 satisfy the relation of i<h.

Accordingly, the grommet 1 and the wire harness WH can increase the force of pressing the water-stop portion 11 against the inner edge of the through-hole 101 with the relation of the inner diameter i of the water-stop portion 11 and the outer diameter h of the pressing portion 20. As a result, the grommet 1 and the wire harness WH enable the water-stop portion 11 to be pressed against the inner edge of the through-hole 101 reliably.

In the grommet 1 and the wire harness WH in the embodiment, the water-stop portion 11 has, in the outer circumference thereof, the recess 11A that is fitted in the through-hole 101, and the recessed part of the recess 11A is formed to have the smallest thickness in the other parts of the water-stop portion 11.

Accordingly, in the grommet 1 and the wire harness WH, the pressing force is more difficult to be absorbed in the recessed part of the recess 11A with a small thickness than parts with large thicknesses, due to fitting of the recess 11A in the through-hole 101 and flexibility of the recessed part of the recess 11A, thereby improving adhesion in pressing of the water-stop portion 11 against the inner edge of the through-hole 101. As a result, the grommet 1 and the wire harness WH enable the water-stop portion 11 to be pressed against the inner edge of the through-hole 101 reliably.

In the grommet 1 and the wire harness WH in the embodiment, the pressing portion 20 is formed into the continuous ring shape.

Accordingly, the grommet 1 and the wire harness WH generate the force of pressing the water-stop portion 11 against the inner edge of the through-hole 101 continuously in the circumferential direction of the ring shape. As a result, the grommet 1 and the wire harness WH enable the water-stop portion 11 to be pressed against the inner edge of the through-hole 101 reliably.

In the grommet 1 and the wire harness WH in the embodiment, the pressing portion 20 is made of the material harder than that of the water-stop portion 11.

Accordingly, the grommet 1 and the wire harness WH generate the force of pressing the soft water-stop portion 11 against the inner edge of the through-hole 101 by the relatively hard pressing portion 20. As a result, the grommet 1 and the wire harness WH enable the water-stop portion 11 to be pressed against the inner edge of the through-hole 101 reliably.

The above-mentioned grommet 1 and wire harness WH according to the embodiment of the present invention are not limited to those in the above-mentioned embodiment and can be variously modified within a range described in the scope of the claims. The grommet 1 and the wire harness WH according to the embodiment may be configured by appropriately combining components in the above-mentioned embodiment and modifications.

The grommet and the wire harness according to the present embodiment do not need force of pressing the water-stop portion of the main body against the inner edge of the through-hole in insertion of the water-stop portion into the through-hole and eliminates an operation of inserting the main body into the through-hole against the pressing force that causes poor workability. The grommet is thereafter mounted in such a manner that the water-stop portion is pressed against the inner edge of the through-hole by the pressing portion. As a result, the grommet enables the operation of inserting the water-stop portion of the main body into the through-hole and the operation of pressing the water-stop portion against the inner edge of the through-hole by the pressing portion to be separated, thereby ensuring water-stop performance and improving mountability.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A grommet comprising:
a main body having a ring-shaped water-stop portion that is inserted into a through-hole formed in an attachment panel for stopping water and a cylindrical portion that is provided to penetrate through an annular inner side of the water-stop portion and through which a wiring material is inserted; and
a pressing portion inserted into the annular inner side of the water-stop portion in the main body and pressing the water-stop portion against an inner edge of the through-hole.

2. The grommet according to claim 1, wherein
the water-stop portion and the pressing portion have contact surfaces making surface contact with each other.

3. The grommet according to claim 1, wherein
an inner diameter i of the water-stop portion and an outer diameter h of the pressing portion satisfy a relation of i<h.

4. The grommet according to claim 2, wherein
an inner diameter i of the water-stop portion and an outer diameter h of the pressing portion satisfy a relation of i<h.

5. The grommet according to claim 1, wherein
the water-stop portion has, in an outer circumference, a recess that is locked in the through-hole, and a recessed part of the recess is formed to have a smallest thickness in the other parts of the water-stop portion.

6. The grommet according to claim 2, wherein
the water-stop portion has, in an outer circumference, a recess that is locked in the through-hole, and a recessed part of the recess is formed to have a smallest thickness in the other parts of the water-stop portion.

7. The grommet according to claim 3, wherein
the water-stop portion has, in an outer circumference, a recess that is locked in the through-hole, and a recessed part of the recess is formed to have a smallest thickness in the other parts of the water-stop portion.

8. The grommet according to claim 4, wherein
the water-stop portion has, in an outer circumference, a recess that is locked in the through-hole, and a recessed part of the recess is formed to have a smallest thickness in the other parts of the water-stop portion.

9. The grommet according to claim 1, wherein
the pressing portion is formed into a continuous ring shape.

10. The grommet according to claim 2, wherein
the pressing portion is formed into a continuous ring shape.

11. The grommet according to claim 3, wherein
the pressing portion is formed into a continuous ring shape.

12. The grommet according to claim 4, wherein
the pressing portion is formed into a continuous ring shape.

13. The grommet according to claim 5, wherein
the pressing portion is formed into a continuous ring shape.

14. The grommet according to claim 6, wherein
the pressing portion is formed into a continuous ring shape.

15. The grommet according to claim 1, wherein
the pressing portion is made of a material harder than the water-stop portion.

16. The grommet according to claim 2, wherein
the pressing portion is made of a material harder than the water-stop portion.

17. The grommet according to claim 3, wherein
the pressing portion is made of a material harder than the water-stop portion.

18. The grommet according to claim 5, wherein
the pressing portion is made of a material harder than the water-stop portion.

19. The grommet according to claim 9, wherein
the pressing portion is made of a material harder than the water-stop portion.

20. A wire harness comprising:
a wiring material having conductivity; and
a grommet provided for the wiring material, wherein the grommet includes:
a main body having a ring-shaped water-stop portion that is inserted into a through-hole formed in an attachment panel for stopping water and a cylindrical portion that is provided to penetrate through an annular inner side of the water-stop portion and through which the wiring material is inserted; and
a pressing portion inserted into the annular inner side of the water-stop portion in the main body and pressing the water-stop portion against an inner edge of the through-hole.
